(19) United States
(12) Patent Application Publication
(10) Pub. No.: US 2026/0060360 A1
(43) Pub. Date: Mar. 5, 2026

(54) SPEAKER SYSTEM FOR A HELMET

(71) Applicant: Cardo Systems, Ltd., Ra’anana (IL)

(72) Inventors: Gerhard Rudolf Pfaffinger, Straubing (DE); Markus Ewald Christoph, Straubing (DE)

(73) Assignee: Cardo Systems, Ltd., Ra’anana (IL)

(21) Appl. No.: 19/385,468

(22) Filed: Nov. 11, 2025

Related U.S. Application Data
(63) Continuation of application No. PCT/IB2024/056301, filed on Jun. 27, 2024.
(60) Provisional application No. 63/523,538, filed on Jun. 27, 2023.

(51) Int. Cl. A42B 3/30; H04R 1/02; H04R 1/08; H04R 1/10; H04R 1/28

(52) U.S. Cl. CPC A42B 3/30; H04R 1/023; H04R 1/025; H04R 1/028; H04R 1/08; H04R 1/1008; H04R 1/1083; H04R 1/2826; H04R 2460/01

(57) ABSTRACT

A helmet speaker system includes a helmet shell with a helmet impact liner inside the helmet shell. A hole is formed in the helmet impact liner, the hole penetrating through the helmet impact liner. A speaker is fixed in the hole. A space formed between the helmet impact liner and the interior sidewall of the helmet shell is directly acoustically connected to a rear portion of the speaker fixed in the hole. The speaker is configured to use the space to produce improved sound, particularly with respect to low frequency sound.

### CROSS REFERENCE TO RELATED APPLICATIONS

This application is a continuation of International Application No. PCT/IB2024/056301, filed Jun. 27, 2024, which claims priority to U.S. Provisional Application No. 63/523,538, filed Jun. 27, 2023. The entire contents of both applications are hereby incorporated herein by reference.

### BACKGROUND

This disclosure relates to the field of speaker systems integrated into helmets. Specifically, this disclosure is related to improving sound quality of speaker systems that are integrated into the interior of a helmet.

Helmets are widely used safety devices intended to protect the head of a user from an impact. They are used in a various activities, including motorsports, bicycling, snow sports, construction activities, and industrial use. Helmets typically have a hard outer shell and some form of liner or padding in the interior sidewall of the helmet that improves comfort and fit for the user, as well as improving helmet impact absorption. Many helmets are designed to enclose the ears of the user inside the helmet. In these types of helmets, and in other helmets used in high-noise environments, a speaker system can be placed inside the helmet to create sounds for the user. The speaker system is typically placed in a recess formed in the liner sized to accept the speaker. This recess is a closed space without any openings or holes in the liner. These speakers can be used to play music, for wireless communication, and to implement active noise canceling to protect the user's hearing.

However, the available space to place the speaker in a helmet is limited, and thus the speakers are generally limited to a relatively small size. Further, helmets are mostly mobile devices, which means any electronics devices integrated into the helmet, such as the speaker, must be battery powered. This limits the overall power available to the speaker. Finally, the mounting of the speaker in a closed recess conforming to the shape of the speaker restricts the ability for the speaker to emit sound properly. This issue is exacerbated by a noise cancellation issue that generally occurs when speakers are not mounted to a closed speaker box (as is the case with a typical helmet speaker). The rear of a speaker emits the same sound as the front of as speaker, but 180 degrees out of phase. When the speaker is simply placed in a recess, the out of phase sounds emitted by each side of the speaker at least partially cancel out, reducing sound emitted. This is usually addressed by reducing the sound emitted by the rear portion by the use of sound deadening elements like foams, but this solution is undesirable because it only partially addresses the problem and adds weight and complexity.

These factors generally mean that speakers in helmets do not have adequate sound quality. This is especially the case with low frequency or bass response of the speaker system. Bass response is generally linked to speaker size, where larger speakers result in improved bass response. The small size and limited power of helmet speakers reduces bass response. Thus, there is a need to improve the bass response of helmet speakers without affecting helmet size or power requirements.

A solution to this issue is to use ear cups or cushions placed inside the helmet that form a sealed chamber around the ear, much like over-ear headphones. These systems do have improved bass response, but they have several disadvantages. First, they rely on a good seal between the ear cup and the user's head, which can be difficult to achieve in real-word conditions due to variables in helmet fit and use. Second, the cushions must be in direct, sealing contact with the user's head, which combined with the sealed ear cup chamber, can cause heat to build up and decrease user comfort. Finally, the ear cup can provide excess passive sound reduction, which is regulated in some jurisdictions. Thus, there remains the need for an improved helmet speaker system that does not rely on an ear cushion.

### BRIEF SUMMARY OF THE INVENTION

In a first embodiment, a helmet includes a helmet shell, and a helmet impact liner inside the helmet shell, the helmet impact liner having an interior side configured to face the interior of the helmet and an exterior side configured to face the exterior of the helmet. A hole is formed in the helmet impact liner connecting the interior side and the exterior side. A speaker is disposed in the hole, with a rear portion of the speaker acoustically directly linked through a cavity in the hole with the exterior side of the helmet impact liner, and a front portion of the speaker in acoustically directly linked with the interior side of the helmet impact liner. A space is formed between at least a part of an interior sidewall of the helmet shell and the exterior side of the helmet impact liner, with the space being acoustically directly linked with the speaker.

In a second embodiment, a method of improving bass response of a speaker disposed in a helmet includes forming a hole through a helmet impact liner and mounting the speaker in the hole such that a rear portion of the speaker is acoustically directly linked with an exterior side of the helmet impact liner. A space is formed between at least part of the exterior side of the helmet impact liner and an interior sidewall of a helmet shell when mounting the helmet impact liner to the interior sidewall of a helmet shell. The space and a rear portion of the speaker mounted in the hole are directly acoustically connected. Finally, the speaker is used to produce sound by using the space.

In a third embodiment, a method of active noise cancellation using a speaker disposed in a helmet impact liner includes receiving data regarding ambient sound levels at a controller. The controller then generates a noise cancellation sound based on the data. The controller then controls a speaker to generate the noise cancellation sound at least partially through use of a space disposed between the helmet impact liner and a helmet shell that is directly acoustically connected to a portion of the speaker.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 is a perspective view of a helmet according to certain embodiments.

FIG. 2 is a cross section view of the helmet of FIG. 1.

FIG. 3 is a side view of a helmet impact liner according to certain embodiments.

FIG. 4 is a partial section view of a portion of helmet shell and helmet impact liner according to an embodiment.

FIG. 5 is a cross section of the helmet impact liner of FIG. 2.

FIGS. 6A-6B are an exploded view of a speaker and speaker mount according to certain embodiments.

FIG. 7A-7B are a system diagram of an active noise cancellation helmet speaker system according to certain embodiments.

FIG. 8 is a diagram illustrating exemplary test results based on certain embodiments.

FIGS. 9A-9B are a method of use of a speaker in an active noise cancellation system according to certain embodiments.

FIG. 10 is a cross section view of a helmet according to certain embodiments.

FIG. 11 is a side view of a portion of a helmet impact liner according to certain embodiments.

FIG. 12 is a cross section view of a speaker mount and speaker secured in a hole formed in a helmet impact liner according to certain embodiments.

In the drawings, like reference numbers generally indicate identical or similar elements. Additionally, generally, the left-most digit(s) of a reference number identifies the drawing in which the reference number first appears.

### DETAILED DESCRIPTION

Reference will now be made in detail to representative embodiments illustrated in the accompanying drawings. References to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such a feature, structure, or characteristic in connection with other embodiments whether or not explicitly described.

The limited size and power available for helmet speaker systems results in reduced speaker performance, particularly for low frequency or bass sounds (for example, sound frequencies from 50 Hz to 300 Hz). An embodiment of the present disclosure addresses this issue, among other benefits, by placing a hole through the helmet impact liner and mounting the speaker in the hole. The rear portion of the speaker is acoustically directly linked with a space or gap disposed between the helmet impact liner and the interior sidewall of the helmet shell. The speaker is able to use the air volume created by the space to provide improved bass response without requiring a larger speaker or more speaker power consumption.

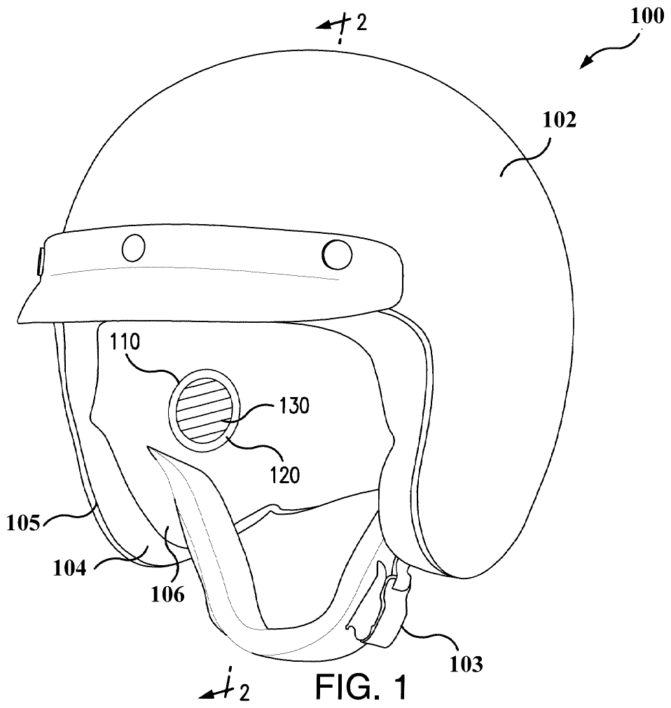

FIG. 1 is a perspective view of a helmet 100 according to embodiments of the present disclosure. Visible in FIG. 1 is a helmet shell 102 that forms the outer portion of helmet 100, and a helmet impact liner 104 placed inside helmet shell 102. Also shown is a helmet strap 103 for securing helmet 100 to a user. A speaker 130 is fixed in a hole 110 in helmet impact liner 104 with a speaker mount 120.

As seen in FIG. 1, a helmet 100 is adapted to be worn by a user. Helmet 100 can be configured to protect the head of a user from impacts in any suitable setting, such as motorsports (including motorcycles, dirt bikes, all-terrain vehicles), bicycling, snow sports, construction activities, and industrial use (such as fire helmets). FIG. 1 shows an open face helmet 100, but it should be understood that any other suitable form of helmet 100 is compatible with this disclosure, including full face helmets and flip up helmets. Helmet 100 includes a helmet shell 102. Helmet shell 102 is the outer portion of helmet 100, and is a rigid structure formed in a shape configured to receive the head of a user. Helmet shell 102 can be a single or multiple layers, and is typically formed from a suitable impact resistant, rigid, and lightweight material such as a plastic or composite material. The interior of the helmet shell 102 is referred to herein as the interior wall of the helmet shell 102 to distinguish it from the interior of the helmet 100.

A helmet impact liner 104 is disposed inside helmet shell 102. Helmet impact liner 104 is designed to conform to the head of the user to improve fit of the helmet and comfort of the user. Helmet impact liner 104 is also designed to mitigate the transmission of an impact from helmet shell 102. Helmet impact liner 104 can be formed from any suitable flexible material, such as rubber or foam materials. For example, helmet impact liner 104 can be made from expanded polystyrene foam. Helmet impact liner 104 can also be covered with cushions, coated with a fabric or textile material to improve user comfort, or both.

In some embodiments, helmet impact liner 104 is fixed to the interior sidewall of helmet shell 102 through the use of any suitable technique, such as the use of mechanical fasteners, adhesives, snap fasteners, or hook and loop fasteners. This fixing can be permanent or removable. Helmet impact liner 104 can be formed in one piece, or in multiple pieces. For ease of reference, helmet impact liner 104 has an exterior side 105 that faces helmet shell 102, and an interior side 106 that faces the head of the user when helmet 100 is worn.

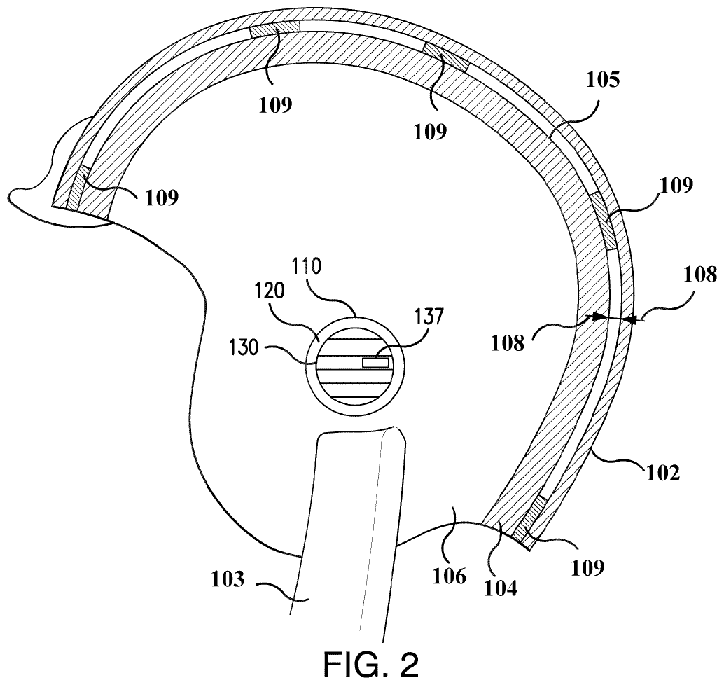

FIG. 2 is a cross-section of helmet 100 as shown in FIG. 1 by cross-sectional arrows. The cross-section provides further detail of the interior of helmet 100, including helmet speaker 130, as well as showing a space 108 formed between helmet impact liner 104 and the interior side of helmet shell 102. As will be explained below, space 108 can be a preexisting space that is already present in an existing helmet 100. In other cases, space 108 may be designed into helmet 100 using the techniques discussed here. Space 108 can be an existing gap or space created by the mounting methods used to fix helmet impact liner 104. For example, if a hook and loop fastener is used space 108 will be created as a result of the depth required for the hook and loop fastener. In some embodiments, a set of spacers 109 are placed between helmet impact liner 104 and helmet shell 102 to ensure that space 108 is formed. These spacers 109 can be made of any suitable material, including the same material as helmet impact liner 104. In some embodiments, spacers 109 are permanently or removably fixed to an interior sidewall of helmet shell 102. Spacers 109 can be distributed around helmet impact liner 104 to ensure the symmetrical formation of space 108.

In some embodiments the average distance between helmet impact liner 104 and the interior sidewall of helmet shell 102 (the depth of space 108) is between two and four millimeters. Other distances are possible depending on helmet configuration and desired characteristics. For example, this distance can be selected to increase or decrease the volume defined by space 108 to alter the acoustic performance of speaker 130, as will be discussed below. For example, spacers 109 can be made thicker or thinner, or added or removed, to change the dimensions of space 108. The shape of helmet impact liner 104 can also be altered to change space 108 by, for example, removing some material from exterior side 105 to ensure space 108 is continuous.

Space 108 is not a completely sealed volume. In most helmets 100, various holes are made in helmet impact liner 104 to accommodate, for example, the need to fix helmet impact liner 104 to helmet shell 102 or to fix helmet 100 to a user's head. Additional openings can also be intentionally formed in helmet impact liner 104 to ensure space 108 is not completely sealed. This is necessary to ensure proper sound transmission from space 108 to a user.

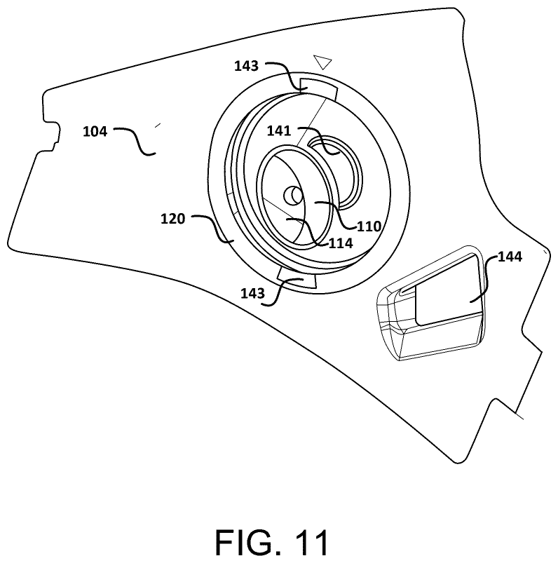

Also seen in FIGS. 1 and 2 is a helmet strap 103. Helmet strap 103 is fixed to the lower portion of helmet shell 102 and can be linked around the chin of a user to fix helmet 100 to the user's head. According to some embodiments, the helmet strap may be attached to the helmet shell 102 and pass through a slot 144 formed in the helmet impact liner 104, as identified in FIG. 11.

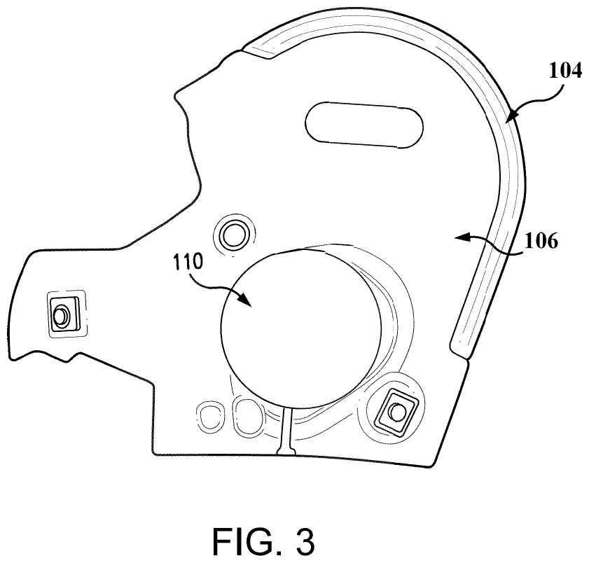

A speaker 130 is disposed in a hole 110 in helmet impact liner 104. It is preferable for speaker 130 to be disposed in hole 110 such that there is no rattling or movement of speaker 130 that can cause unwanted noise, particularly when speaker 130 is emitting sound. For example, speaker 130 may be secured such that speaker 130 produces no mechanical sounds when helmet 100 is vibrated. FIG. 2 shows speaker 130 disposed in helmet impact liner 104, and FIG. 3 shows helmet impact liner 104 alone, with hole 110 visible. In the example of FIG. 3, hole 110 penetrates all the way through helmet impact liner 104, from exterior side 105 (as shown in FIGS. 1, 2) to interior side 106.

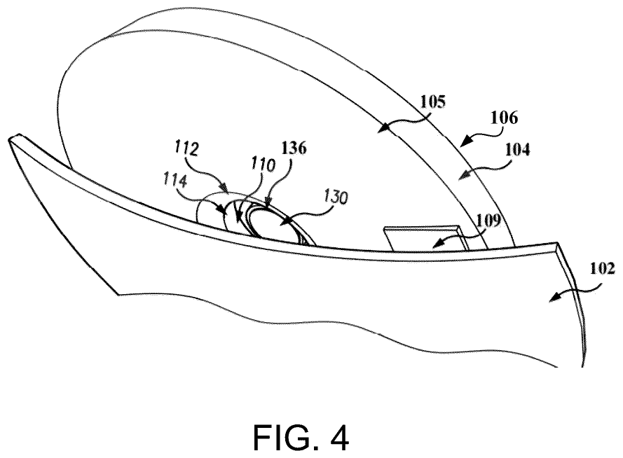

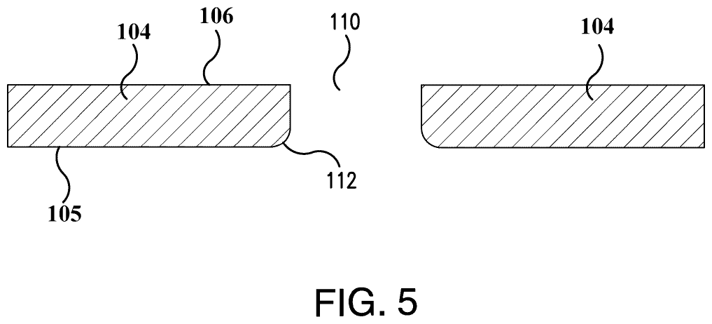

FIG. 4 is a partial section view showing the back or exterior side of 105 helmet impact liner 104 including hole 110. A portion of helmet shell 102 is visible, as well as elements related to helmet speaker 130. As seen in FIG. 4, where hole 110 and exterior side 105 may curve into hole 110, as illustrated by a radius 112. The space between the exterior side 105 of the helmet impact liner 104 is formed at least in part by spacer 109, as previously described. FIG. 5 shows a cross section of helmet impact liner 104 taken through hole 110 showing structural details of hole 110. The curvature of the exterior side 105 of the helmet impact liner 104 into the hole 110 is shown to be formed by the a radius 112.

Hole 110 can have a diameter ranging from 20 millimeters to 60 millimeters, for example. In other examples, hole can have an even smaller diameter, as small as 5 millimeters. In some embodiments, the diameter of hole 110 may be smaller or larger than such examples and is chosen based on the diameter of speaker 130, the power of the speaker 130, the sound pressure capabilities of the cavity 114, safety regulations, and/or other design considerations. For example, the diameter of hole 110 may be sized to be slightly larger than the external diameter of speaker 130. Hole 110 can be a circular hole, or it can be formed as non-circular hole. Any desired shape can be used for hole 110. For example, hole 110 might be shaped in a non-circular, oval shape to closely follow the perimeter of an oval speaker 130. Hole 110 may also be shaped to avoid other elements of helmet 100, such as fixtures attaching helmet impact liner 104 to helmet shell 102.

One or more speakers 130 may be disposed in helmet impact liner 104. For example, in some embodiments, one speaker 130 is positioned such that speaker 130 will be aligned with one ear of the user, and another speaker 130 positioned such that the other speaker 130 will be aligned with the other ear of the user when helmet 100 is worn. More specifically, the center of a speaker 130 may be aligned with the axis of the user's ear canal, within approximately ten millimeters. In some embodiments, hole 110 may start at interior side 106 as a single, large opening formed to accommodate speaker 130, but may then transition to a series of smaller holes that continue through helmet impact liner 104 to exterior side 105. In other examples, multiple speakers can be used for each ear side.

Speaker 130 is mounted in hole 110 such that the exterior perimeter of speaker 130 is sealed to helmet impact liner 104. In particular, the exterior perimeter of speaker 130 may be sealed to helmet impact liner 104 such that a substantially airtight seal is formed between speaker 130 and helmet impact liner 104. Details regarding formation of this seal are discussed below. In addition, the seal may secure speaker 130 to helmet impact liner 104 to prevent speaker 130 from rattling.

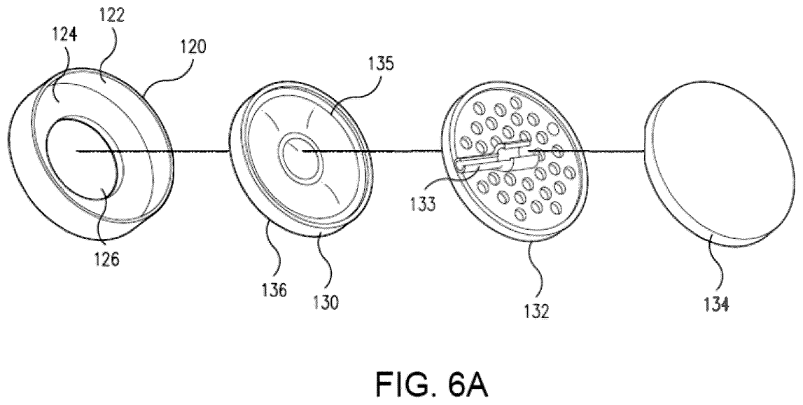

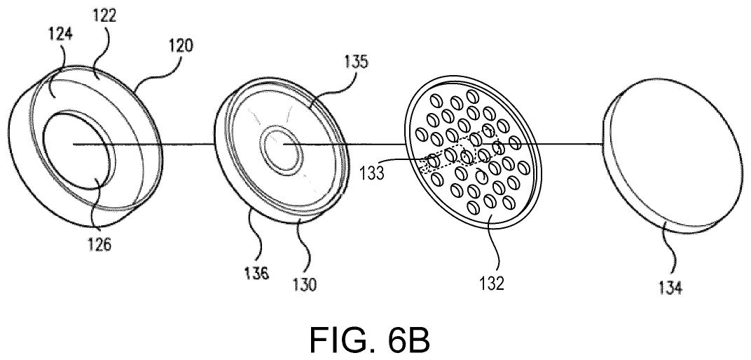

In this manner, a rear portion 136 of speaker 130 (the portion positioned closer to helmet shell 102) is acoustically directly linked or coupled with space 108 (as shown in FIG. 2) through a cavity 114 defined by hole 110 and the rear portion 136 of speaker 130. Acoustically directly coupled here means that there is a direct, unimpeded, or if desired specifically impeded (e.g., by way of defined acoustic resistors), acoustic link between the relevant elements in that there are substantially no sound attenuating elements (beyond any specifically defined elements) interposed between the relevant elements. In this case, there is a clear and defined path through air alone between rear portion 136 and space 108. Cavity 114, and space 108, are an empty air space behind speaker 130 that acts as a back volume for speaker 130. The front portion 135 of speaker 130 (as shown in FIGS. 6A-6B) is sealed from rear portion 136 of the speaker and is acoustically directly linked with the interior of helmet 100 where the user's head is accommodated. This configuration enables speaker 130 to use the air volume of space 108 to enlarge the overall size of the cavity 114 and as such improve bass response, and thus overall sound quality, without requiring additional power input to or a size increase of speaker 130.

FIG. 11 shows an alternate embodiment of a helmet impact liner 104 alone, with hole 110 visible. In the example of FIG. 11, helmet impact liner 104 has a cavity 114 shaped to receive a speaker 130. The hole 110 is shown as beginning inside the cavity 114 and penetrating through the helmet impact liner 104 at an angle relative to the speaker mount 120. In other words, the cavity 114 in this example does not penetrate through the helmet impact liner 104 perpendicular to the rear portion 136 of speaker 130. Instead, sound waves emitted from the rear portion 136 of the speaker 130 enter the cavity 114 in a direction that is away from and at an angle relative to the rear portion 136 of the speaker 130, as shown in FIG. 11 by the small hole at the bottom of the cavity which penetrates the helmet impact liner 104. In some examples, cavity 114 is directly acoustically linked with space 108 defined between the helmet impact liner and the interior side of the helmet shell 102. In other examples, cavity 114 is sealed by the helmet impact liner 104 such that cavity 114 is not directly acoustically linked with the space 108. In other examples, FIG. 11 further shows a notch 141 formed in the cavity 114 of the helmet impact liner 104 adjacent to the hole 110 to provide additional spacing between the helmet impact liner 104 and the rear portion 136 of the speaker 130. One or more notches 141 may be present in other embodiments to prevent contact between the rear portion 136 of the speaker 130 and the helmet impact liner 104. Notches 141 may for instance be shaped to accommodate the shapes of component(s) present on the rear portion 136 of a given speaker 130.

Speaker 130 can be any suitable standard speaker used in helmet speaker systems. However, speakers that are not intended to be connected to space 108 as discussed above typically have relatively limited low frequency response caused by a reduced amplitude of movement of the speaker membrane. Thus, when selecting a speaker design for the present disclosure, a speaker with improved bass response, by having an increased movement of the speaker membrane, can be utilized. For example, speaker 130 may have an acoustically effective membrane area of greater than or equal to 1000 mm² to ensure a minimum low frequency effectiveness. Speaker 130 should also have a moving mass of less than 1 gram. Speaker 130's impedance can be more than 8 ohms. Speaker 130's linear membrane excursion should be more than 1.5 mm at peak excursion. Speaker 130 may also include one or more acoustic resistance elements disposed at the rear portion 136 of the speaker 130 configured to modify a directivity of the speaker 130 to ideal planar radiation. The directivity of the speaker 130 (measured in its nearfield) can be altered by changing an acoustic resistance of the speaker 130. The acoustic resistance of the speaker 130 can be altered by modifying its acoustic resistor pads, which may be attached to the perforated backside of the speaker's basket. This radiation pattern can improve speaker efficiency when used in conjunction with space 108.

Radius 112, shown in FIGS. 4 and 5, assists in the acoustic link between speaker 130 and space 108 because it enables a smooth transition that avoids turbulences and improves the propagation of sound waves to and through space 108. This technique works even if space 108 is not completely sealed, for example because of penetrations by fasteners securing helmet impact liner 104 to helmet shell 102. As long as space 108 is mostly defined and contained by helmet impact liner 104 and helmet shell 102, there will be a substantial improvement in bass response of speaker 130 using embodiments of this disclosure.

As discussed above, the direct acoustic link between rear portion 136 of speaker 130 and space 108 is necessary for proper functioning of the speaker system. Thus, the area of exterior side 105 of helmet impact liner 104 that contains the exit of hole 110 must be spaced apart from helmet shell 102. This allows for the acoustic link between hole 110 and space 108. This can be accomplished by, for example, shaping helmet impact liner 104 or by the use of spacers 109 placed in appropriate positions.

In an embodiment, speaker 130 is secured in hole 110 by a speaker mount 120. As seen in the exploded view of FIG. 6, speaker mount 120 has an outer wall 122 formed in a cylindrical shape configured to receive speaker 130. Speaker mount 120 also has a shelf 124 disposed at one end of outer wall 122 and extending radially inward from outer wall 122. A speaker mount hole 126 is formed at the center of and extending through shelf 124. Speaker mount hole 126 may be between 10 millimeters and 60 millimeters in diameter. The dimensions of the speaker mount 120 and speaker mount hole 126 may vary in other embodiments, depending on helmet configuration, speaker size, and other variables.

Speaker 130 is fixed in speaker mount 120 by any suitable acoustically tight or airtight method including, for example, an adhesive applied between speaker 130 and speaker mount 120. In some embodiments, shelf 124 can act as a stop that aligns speaker 130 in speaker mount 120, and also serves to increase the amount of area available for the adhesive. Acoustically tight may refer to sealing wherein sound traveling towards the sealing reflects off the seal with little to no attenuation, or when substantially no acoustic waves are transmitted across the seal. Airtight may similarly refer to blockage of sound waves traveling towards the sealing, wherein no air channel exists for the acoustic waves to propagate.

Speaker mount 120 is, in turn, placed in hole 110 and sealed to hole 110 as shown in FIGS. 1 and 2. This can be accomplished by any suitable acoustically tight or airtight technique, including, for example, the use of adhesives between speaker mount 120 and the interior of hole 110. In this way, speaker 130 is sealed to speaker mount 120, and speaker mount 120 is sealed to helmet impact liner 104. Further, the speaker mount 120 allows for the speaker 130 to be sealed within the hole 110 without contacting the helmet impact liner. When the speaker 130 is sealed within the hole 110 without contacting the helmet impact liner 104, vibrations communicated between the speaker 130 and the helmet impact liner 104 may be minimized. Additionally, spacing between the speaker 130 and the helmet impact liner 104 may allow for sound waves emitted from the rear face of the speaker 130 to travel into the hole 110 compared to directly traveling into the helmet impact liner 104. In some examples, the speaker 130 may be inserted directly into hole 110 and cavity 114 in an acoustically sealed manner without the use of the speaker mount 120.

In other embodiments, such as shown in FIG. 11, speaker mount 120 is attached to the helmet impact liner 104 and is provided with one or several snap locks 143. Speaker 130 is fixed to the speaker mount 120 by way of the snap locks 143. For instance, speaker 130 may have protrusions on its perimeter corresponding to snap locks 143. The speaker 130 may be inserted into the speaker mount 120 and rotated until the protrusions on its perimeter are caught by snap locks 143 to fix speaker 130 into place relative to the speaker mount 120. Snap locks 143 or other tight coupling means can be configured such that the speaker 130 may be fixed to speaker mount 120 while maintaining an airtight seal between speaker 130 and helmet impact liner 104.

Also shown in FIG. 6 is a speaker grill 132. Speaker grill 132 is fixed to front portion 135 of speaker 130 and is designed to prevent physical damage to speaker 130 caused by objects impacting speaker 130. Holes are formed in speaker grill 132 to improve sound transmission from speaker 130. In some embodiments, speaker grill 132 is acoustically transparent at the relevant frequencies due to the holes. Integrated into speaker grill 132 is a microphone mount 133. Microphone mount 133 is configured to hold a microphone 137 (see FIG. 2). Microphone 137 may be a MEMs (micro-electromechanical systems), ECM (electret condenser microphones), or equivalent device and the inlet of microphone 137 may have a protective cover (not shown) to protect microphone 137 from any debris that may enter. Microphone mount 133 is positioned to substantially align microphone 137 with the axis of a user's ear canal. In some embodiments, this alignment is within 10 millimeters, accounting for the width of the microphone mount 133 and the width of the speaker grill 132. Speaker grill 132 may also have a hole positioned adjacent to microphone 137 to improve microphone sensitivity.

An acoustically transparent or semi-transparent foam 134 may be fixed to the exterior side of speaker grill 132. Acoustically transparent or semi-transparent foam 134 further prevents any objects from impacting front portion 135 of speaker 130. Another acoustically transparent or semi-transparent foam (not shown) can be placed over rear portion 136 of speaker 130 for the same purpose. In some embodiments, foam 134 can also include an acoustically transparent fabric, or, in the alternative, be formed entirely from an acoustically transparent fabric. In some embodiments, foam 134 includes an opening to accommodate microphone mount 133 (and microphone 137). In some embodiments, this opening is at least 5 millimeters in diameter. This opening can improve the functionality of microphone 137. Microphone mount 133 and acoustic foam 134 can be formed from any suitable material, and can be mounted by any suitable method, including adhesives and snap fit.

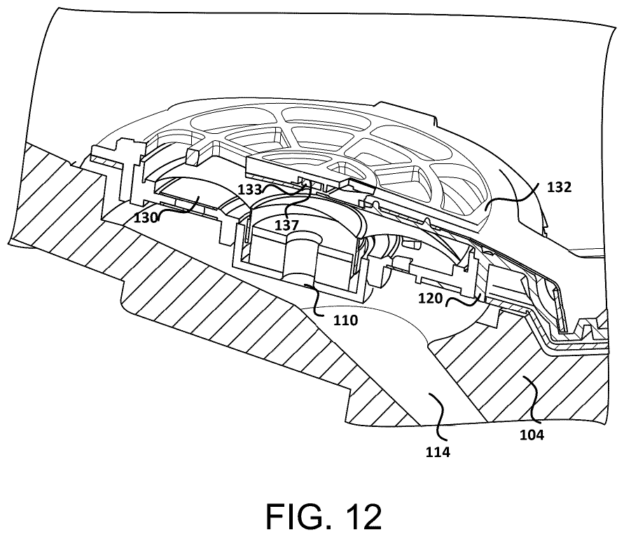

The microphone mount 133 may be positioned on either side of the speaker grill 132 and may be positioned to direct the microphone 137 in various directions. In the embodiment shown in FIG. 6A, the microphone mount 133 is positioned on a front side (facing the user's ear) of the speaker grill, capable of holding the microphone 137 at a 90 degree angle, e.g. perpendicular to the speaker grill 132. In the embodiment of FIG. 6B, the microphone mount 133 is shown in dotted lines to indicate its positioning on a rear side of the speaker grill 132, where the rear side of the speaker grill 132 faces the membrane of the speaker 130. In another example, shown in FIG. 12, the microphone mount 133 is positioned on a rear side (facing the membrane of the speaker 130) of the speaker grill 132, the microphone 137 mounted flush with the speaker grill 132 and directly facing the membrane of the loudspeaker. In some cases, it is preferable to position the microphone 137, when held by the microphone mount 133, such that it faces towards the speaker 130, i.e., towards the helmet shell 102. In other cases, it is preferable to position the microphone 137, when held by the microphone mount 133, such that it faces towards the user's ear. By adjusting the positioning and orientation of the microphone 137, delay may be increased or reduced between acoustic signals output by the speaker 130 and received by the microphone 137. Differences in phase and sound pressure level of acoustic waves emitted from the speaker 130 may also motivate positioning and orientation of the microphone 137. Other considerations may motivate the arrangement of microphone 137 onto microphone mount 133, including keeping the arrangement of the speaker 130 and microphone 137 as thin as possible. Thus, microphone 137 may be placed at the bottom of the speaker grill 132 mounted flush with the speaker grill. The microphone may also be arranged to provide a secondary path between the speaker 130 and the microphone to enhance subjective active noise cancellation performance and/or maximizing perceived bass impression.

FIG. 12 is a cross sectional view of a speaker assembly fixed to a helmet impact liner 104 similar to the one shown in FIG. 11. In this example, the speaker mount 120 secures the speaker 130 within a cavity 114 in the helmet impact liner 104. Hole 110 begins in the cavity 114 and penetrates through the helmet impact liner 104 at an angle relative to the speaker mount 120. In the example of FIG. 12, the microphone mount 133 is shown integrated into the rear face of the speaker grill 132 facing the speaker 130. Microphone 137 is positioned in the microphone mount 133. In the same or other examples, positioning the microphone 137 to the microphone mount 133 or other component may be achieved by gluing the microphone 137 into the microphone mount 133. In the example of FIG. 12, the microphone 137 is shown where its body is directly glued into the microphone mount 133 located at the backside of the speaker grill 132 such that its opening is directly facing the membrane of the speaker 130.

While the microphone 137 is shown to be positioned in line with the center of the speaker 130, such that it can be located immediately adjacent to a user's ear canal, other configurations are possible in the same or other embodiments. In particular, it may be desirable to position the microphone 137 in different locations relative to the geometry of the speaker 130 for improved or different acoustic performance. For instance, in the example of FIG. 12, the microphone mount 133 and microphone 137 are shown placed directly over the peak of a membrane of the speaker 130. In other examples, the microphone mount 133 and microphone 137 may be positioned over a valley region of the membranes of the speaker 130, i.e., moved away from the center of the speaker 130, which could provide more space between the microphone 137 and the speaker 130. In such configurations, a lower-profile speaker grill 132 can be accommodate different helmet shells 102.

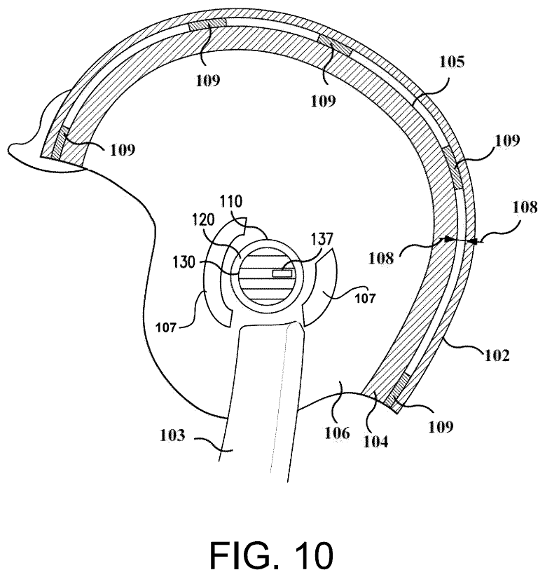

In any of the embodiments discussed above, helmet impact liner 104 can be designed to provide partial enclosure of the ears to improve sound quality. For example, as shown in FIG. 10, helmet impact liner 104 could be designed with additional padding material 107 around the ears to provide a closer fit between the area around the ears and helmet impact liner 104. Another example could be the use of a softer, less dense material to provide a quasi-ear cup without the disadvantages of a full ear cup (for example, decreased comfort). In both examples, a full ear cup configuration is avoided to minimize the drawbacks associated with ear cups discussed above. This additional padding material 107 may be removable and replaceable to allow for a user to optimize fit of helmet impact liner 104. Other portions of helmet impact liner 104 may also be replaceable to optimize fit.

All embodiments of helmet 100 are designed to meet safety standards in the applicable jurisdictions. To this point, hole 110 can be designed to ensure helmet 100 meets the applicable safety standards by minimizing the risk associated with speaker 130 interfering with the impact absorbing properties of helmet impact liner 104. For example, hole 110 can have a different shape, size, or location to improve safety and to meet applicable safety standards. In some examples, instead of one larger hole 110, multiple smaller holes winding through the helmet impact liner 104 with or without penetrating the helmet impact liner 104 may be included. The material surrounding hole 110 can also be modified to improve safety (for example, by being made more or less stiff, or being made thicker or thinner) and to compensate for material removed to form hole 110 sufficient to meet applicable safety standards.

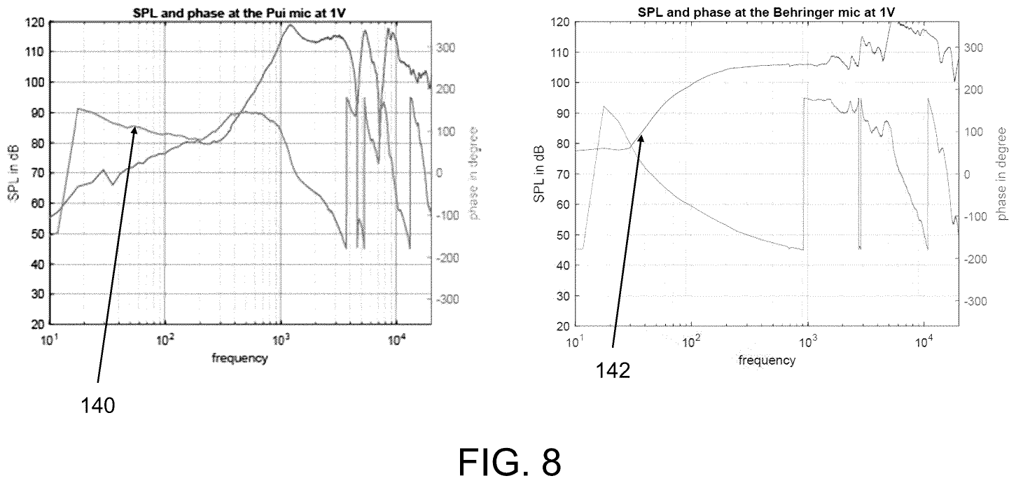

FIG. 8 is a comparative chart showing test results of helmet speakers constructed according to embodiments. As seen in FIG. 8, embodiments of the present disclosure can result in substantial improvements in bass response of speaker 130. The graphs in FIG. 8 are Bode diagrams that show the audio response of a speaker 130 embedded in helmet impact liner 104 without any hole 110 (and with only minimum/no volume in space 108, or with leakage from space 108) in line 140 (in the leftmost graph). A line 142 (in the rightmost graph that is also a Bode diagram) shows the audio response of a speaker 130 mounted to the same helmet impact liner 104 per embodiments of this disclosure (with hole 110 present, linking to space 108 in helmet impact liner 104). The same power is used for both tests. As can be seen, the low frequency response of line 142 (embodiment of this disclosure) is substantially improved over the line 140. For example, at 100 Hz, embodiments of this disclosure as used in this test setup saw an improvement from approximately 75 dB to 100 dB, or a 25 dB improvement. This result is merely exemplary and should not limit the scope. A different configuration may provide for different results.

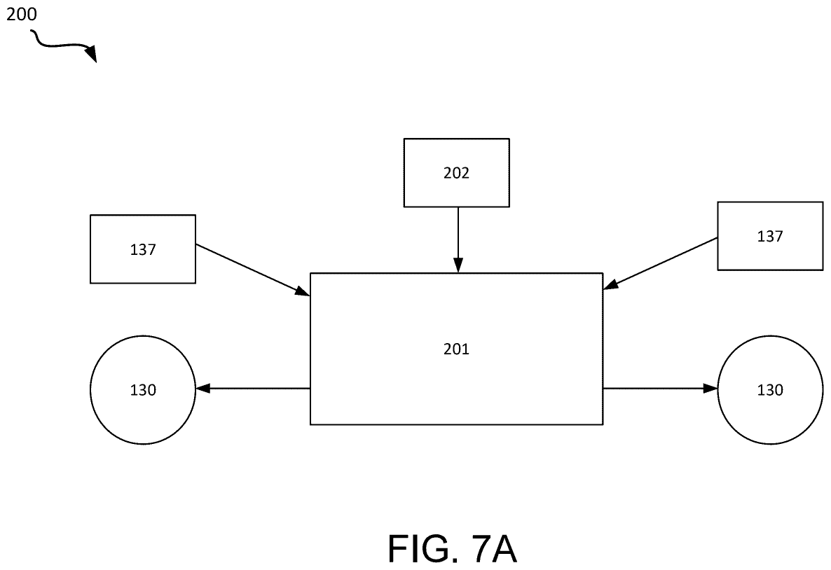

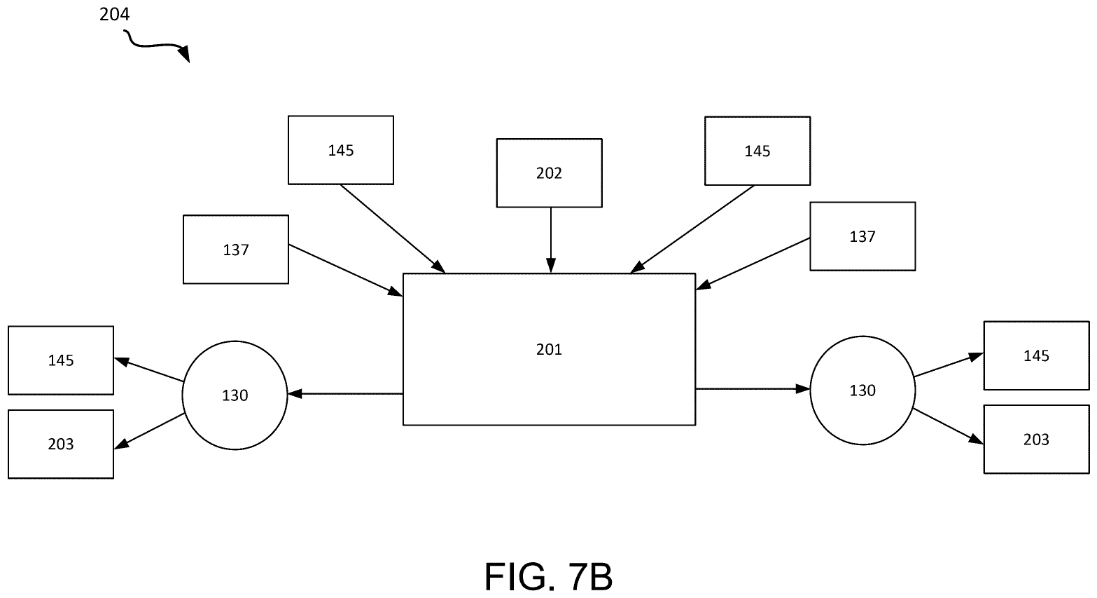

In some embodiments, helmet 100 can include an active noise cancellation system 200. FIG. 7A shows a diagram of this system detailing the operative connections between various components of the disclosure from a control perspective. A controller 201 is operatively connected to speakers 130 and microphones 137. As shown in FIG. 7A, controller 201 is configured to receive data on ambient sound from microphones 137, and to send control signals to speakers 130 that result in sound production. A power source 202 is also operatively connected to controller 201 to provide power for system operation. In some embodiments, power source 202 can be a rechargeable battery. Controller 201 and power source 202 are disposed in helmet 100. For example, controller 201 and power source 202 may be embedded in helmet shell 102. FIG. 7A shows one example of an active noise cancellation system where both sides of an active noise cancellation system (e.g., facing each ear) are processed by a single active noise cancellation controller 201. However, multiple, separate controllers 201 may be used according to other examples. For instance, one independent controller 201 may be used for each side of the helmet corresponding to each ear. In such examples, each controller be connected to at least one speaker 130 and at least one microphone 137, as opposed to the controller 201 receiving at least two microphones 137 and connected to at least two speakers 130 as shown in the example of FIG. 7A.

FIG. 7B shows a diagram of an active noise cancellation system 204 detailing the operative connections between various components of the disclosure from a control perspective. The diagram example of FIG. 7B is similar to that of FIG. 7A but further shows the controller 201 able to receive, recognize, and process useful signals 145. Useful signals 145 may be received from the same microphone 137, as shown in FIG. 7A, or may be received from another signal source such as another microphone 145, or from another processor 145 transmitting to the controller 201 As shown in FIG. 7B, controller 201 is configured to receive data on ambient sound form microphone 137. Controller 201 is also configured to receive useful signals 145. Useful signals can include music signals or voice signals, or any other signals desirable by a user. The controller 201 is able to differentiate undesired ambient noise from microphone 137 and useful signals 145. The controller can then send control signals to speakers 130. The control signals can include signals causing the speakers 130 to generate cancellation sound 203, configured to cancel undesired ambient noise. As shown in the example of FIG. 7B, the controller 201 is also configured to send control signals to speakers 130 including signals causing the speakers 130 to preserve the useful signals 145 such that the useful signals 145 are not negatively affected by the cancellation sound 203.

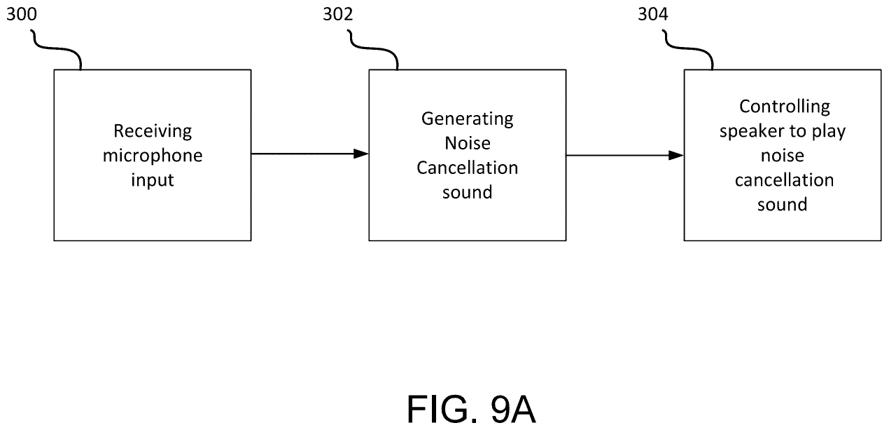

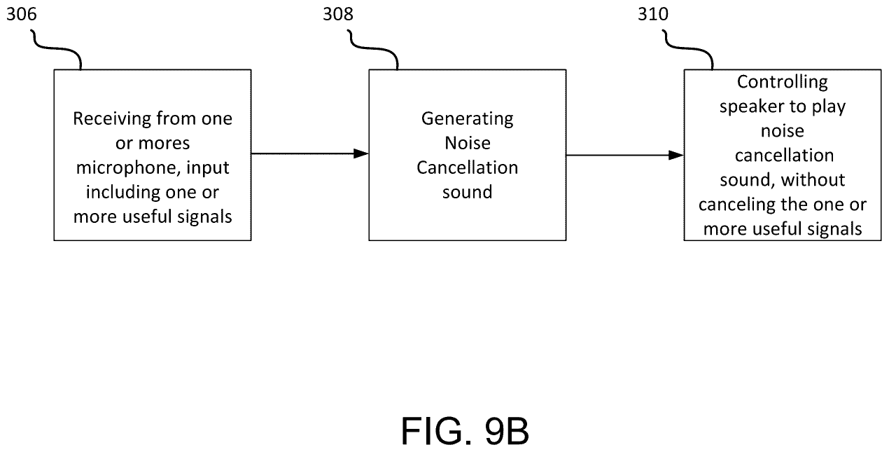

Controller 201 includes suitable processors and memory for storing and performing active noise cancellation. For example, FIG. 9A is a flow chart of a method of active noise cancellation for use with embodiments of the present disclosure. As shown in FIG. 9A, first, in a step 300, controller 201 receives data from one or more microphones 137 regarding the ambient sound detected by microphone(s) 137. It should be noted that, as discussed above, microphone(s) 137 can be placed immediately adjacent to one or more speakers 130 (and thus, immediately adjacent the user's ear canal entrance in some embodiments). This improves the subjective performance of the noise cancellation process because the ambient sound being analyzed is the one detected immediately adjacent the user's ear and speaker(s) 130.

In a step 302, an algorithm stored in controller 201 analyzes the ambient sound and determines a cancellation sound for speaker(s) 130 to emit and reduce or cancel the detected ambient sound. This sound is created as a sound of the same magnitude and frequency, but with opposite phase (i.e., the phase is 180 degrees different). This process is repeated as many times as necessary to account for all different sounds detected by microphone(s) 137.

In a step 304, controller 201 transmits signal(s) to speaker(s) 130 that causes speaker(s) 130 to emit the cancellation sound. These three steps 300, 302, and 304 are repeated to continually optimize the noise cancellation process. As many ambient sounds are generally low frequency sounds, the improved bass response discussed above regarding embodiments of this disclosure improves the effectiveness of the active noise cancellation. The hole 110 forming cavity 114, and connecting to space 108, improves the sound pressure level at low frequencies. Improving the sound pressure level, particularly at low frequencies, may then lead to a better sound and/or better performing active noise cancellation system. Sealing may prevent sound transmission from the rear face of the speaker 130 towards the front face of the speaker, thereby reducing undesired effects of acoustical shortcuts between faces of the speaker 130. This method can be used for as many different speakers 130 and microphones 137 as are present in helmet 100. It should also be understood that controller 201 can be programmed as either a single channel system or a multi-channel system. In a single channel system, each speaker 130 is paired with the input from a single corresponding microphone 137. In a multi-channel system, controller 201 analyzes more than one input from different microphones 137 to determine which signals to play. The optimal blend of the incoming signals can be programmed into controller 201 depending on which speaker 130 is being controlled (e.g., to account for the spatial distribution of both speakers 130 and microphones 137).

FIG. 9B is flow chart of a method of active noise cancellation for use with additional embodiments of the present disclosure. As shown in FIG. 9B, first, in a step 306, controller 201 receives data from one or more microphones 137 regarding the ambient sound detected by microphone(s) 137. The data includes one or more useful signals. The data may also include undesirable signals such as ambient noise requiring cancellation by the active noise cancellation system.

In a step 308, an algorithm stored in controller 201 analyzes the ambient sound and determines a cancellation sound for speaker(s) 130 to emit and reduce or cancel the detected undesirable signals such as ambient sound, similar to the process described with respect to step 302 in FIG. 9A. In addition, the algorithm at step 308 may determine useful signals amid the controller inputs and prevent the generation of noise cancellation sound that would otherwise negatively affect the useful signal such as by cancelling or attenuating the useful signal.

In step 310, controller 201 transmits signal(s) to speaker(s) 130 that causes speaker(s) 130 to emit the cancellation sound 203, similar to step 304 in FIG. 9A. In addition, the cancellation sound 203 played at step 310, as generated at step 308, is formed to cancel the undesired signal, without negatively affecting the useful signal 145.

Controller 201 may also be used to play different sounds from speakers 130. For example, controller 201 may be used to play music through speakers 130. This music may be stored locally on memory in controller 201, or may be transmitted to controller 201 through a suitable means, such as a hard wire connection, like a USB port, or wirelessly, through a transceiver operationally connected to controller 201. Controller 201 may include programming to avoid self-cancellation of desired sounds, such as e.g. music and/or voice signals, by way of corresponding compensation techniques. The controller 201 may be configured to actively cancel noise, through cancellation sound 203, without negatively affecting useful signals 145 such as voice signals, music signals, voice and music signals, or any other desired signals.

The systems and methods above can be applied to existing helmet designs in several different ways. In some embodiments, a method for improving an existing helmet speaker system includes forming hole 110 as discussed above to link speaker 130 to an existing space 108. This approach minimizes the changes required to the existing design. However, the improvements are constrained by the existing speaker 130 and space 108. For example, if space 108 is too small, or has too many openings, the improvement in low frequency response may be less than it could be in a newly designed helmet 100. In other embodiments, a second method for improving an existing helmet speaker system includes designing and implementing the formation of space 108, and then forming hole 110 for speaker 130. This approach can increase sound performance versus the first approach discussed above, but requires additional redesign work. In either approach, speaker 130 can be designed to improve bass response as discussed above. Finally, for both of these approaches, an active noise cancellation system may be added as discussed above.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The use of the modifiers approximately or about in this disclosure are intended to indicate that the relevant element is subject to variation by a tolerance range. Unless otherwise defined, the use of these modifiers with respect to a unit of measure means a tolerance of plus or minus ten percent of the unit of measure. The use of these modifiers with respect to a description such as a shape is intended to allow for variations of that shape due to tolerance issues as would be understood to occur in the art in general.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A helmet, comprising:
a helmet shell;
a helmet impact liner disposed inside the helmet shell, the helmet impact liner having an interior side configured to face an interior of the helmet and an exterior side configured to face the helmet shell;
a hole formed in the helmet impact liner, the hole connecting the interior side and the exterior side of the helmet impact liner;
a speaker disposed in the hole, wherein a rear portion of the speaker is acoustically directly coupled through a cavity in the hole with the exterior side of the helmet impact liner, and a front portion of the speaker is acoustically directly coupled with the interior side of the helmet impact liner; and
a space formed between at least a part of an interior sidewall of the helmet shell and the exterior side of the helmet impact liner, wherein the space is acoustically directly coupled with the rear portion of the speaker.

2. The helmet of claim 1, wherein the speaker is sealed to the hole in an airtight manner.

3. The helmet of claim 1, wherein the speaker is mounted to the helmet impact liner by a speaker mount.

4. The helmet of claim 1, further comprising:
a speaker grill disposed on the front portion of the speaker; and
a microphone placed on the speaker grill.

5. The helmet of claim 4, further comprising a microphone mount disposed on the speaker grill adjacent to the speaker, wherein the microphone is mounted to the microphone mount to contact the speaker grill.

6. The helmet of claim 5, wherein the microphone mount is integrated into a rear face of the speaker grill such that the microphone mount is configured to hold the microphone so that the microphone faces towards the speaker.

7. The helmet of claim 4, further comprising an acoustically transparent fabric covering a front of the speaker grill.

8. The helmet of claim 5, wherein the microphone mount is positioned such that the microphone in the microphone mount is disposed within 10 millimeters of a center of an ear canal entrance of a user when the helmet is worn by the user.

9. The helmet of claim 5, wherein the speaker grill comprises an opening centered around the microphone mount.

10. The helmet of claim 4, further comprising a single or multi-channel controller operatively connected to the speaker and the microphone, the controller configured to control the speaker to produce sound based on inputs from the microphone to actively cancel noise.

11. The helmet of claim 9, wherein producing sound based on the inputs from the microphone actively cancels noise without negatively affecting a useful signal.

12. The helmet of claim 5, wherein the speaker includes a membrane with a peak region and a valley region, further wherein the microphone mount is disposed adjacent to the valley region of the membrane.

13. The helmet of claim 4, further comprising acoustically transparent foam disposed on a front portion of the speaker grill; and
wherein the acoustically transparent foam comprises an opening with a radius of at least 5 millimeters, the opening centered around the microphone.

14. The helmet of claim 1, further comprising a spacer disposed between the helmet impact liner and the helmet shell, the spacer configured to space the exterior side of the helmet impact liner from the interior sidewall of the helmet shell to at least partially form the space.

15. The helmet of claim 1, further comprising one or more notches formed in the helmet impact liner adjacent to the hole shaped to prevent the speaker from contacting the helmet impact liner.

16. A method of improving bass response of a speaker disposed in a helmet, the method comprising:
forming a hole through a helmet impact liner;
mounting the speaker in the hole such that a rear portion of the speaker is acoustically directly linked with an exterior side of the helmet impact liner;
forming a space between at least part of the exterior side of the helmet impact liner and an interior side of a helmet shell when mounting the helmet impact liner to the interior side of a helmet shell;
directly acoustically coupling the space and a rear portion of the speaker mounted in the hole; and
configuring the speaker to produce sound, wherein sound emitted from the rear portion of the speaker passes through the hole into the space.

17. The method of claim 16, further comprising:
mounting a speaker grill on a front portion of the speaker; and
mounting a microphone on the speaker grill.

18. The method of claim 17, wherein the speaker grill includes a microphone mount for receiving the microphone when the microphone is mounted on the speaker grill, further wherein the microphone mount is disposed on the rear face of the speaker grill such that the microphone mount is configured to hold the microphone so that the microphone faces towards the speaker.

19. The method of claim 16, further comprising placing a spacer between the helmet impact liner and the interior side of the helmet shell to form the space.

20. The method of claim 16, wherein mounting the speaker further comprises airtight sealing the speaker to the helmet impact liner such that a front portion of the speaker is not directly acoustically connected to the rear portion of the speaker through the hole.

21. The method of claim 17 further comprising:
providing a single or multi-channel controller operatively connected to the speaker, the controller configured to control the speaker to produce sound based on inputs from the microphone to actively cancel noise.

22. The method of claim 21 wherein the sound does not negatively affect a useful signal.

23. The method of claim 16, wherein the sound comprises a noise cancellation sound.

24. The method of claim 23, wherein the noise cancellation sound is generated through operations comprising:
receiving data regarding ambient sound levels at a controller from a microphone mounted to a front portion of a speaker; and
generating the noise cancellation sound based on the data regarding ambient sound levels.

25. A helmet, comprising:
a helmet shell;
a helmet impact liner disposed inside the helmet shell, the helmet impact liner having an interior side configured to face an interior of the helmet and an exterior side configured to face the helmet shell; and
a hole formed in the helmet impact liner, the hole connecting the interior side and a cavity defined by the hole and a rear portion of a speaker disposed in the hole, wherein the rear portion of the speaker is acoustically directly coupled with the cavity, and a front portion of the speaker is acoustically directly coupled with the interior side of the helmet impact liner.

26. The helmet of claim 25, wherein the rear portion of the speaker is acoustically directly coupled, through the cavity, with a space formed between at least a part of an interior sidewall of the helmet shell and the exterior side of the helmet impact liner.

27. The helmet of claim 25, wherein the cavity does not extend through the exterior side of the helmet impact liner.

28. The helmet of claim 25, wherein the cavity is an empty air space behind speaker that acts as a back volume for speaker.

29. The helmet of claim 25, wherein the cavity is sealed by the helmet impact liner such that cavity is not directly acoustically linked with a space located on an opposite side of the helmet impact liner from the cavity.

30. The helmet of claim 25, where the cavity is angled to not penetrate through the helmet impact liner in a direction perpendicular to the speaker.
